(19) United States
(12) Patent Application Publication
(10) Pub. No.: US 2017/0286988 A1
(43) Pub. Date: Oct. 5, 2017

(54) Profit Share Card

(71) Applicants: Charlie Pye, JR., Hampton, GA (US); Sara A. Pye, Hampton, GA (US)

(72) Inventors: Charlie Pye, JR., Hampton, GA (US); Sara A. Pye, Hampton, GA (US)

(21) Appl. No.: 15/084,081

(22) Filed: Mar. 29, 2016

(51) Int. Cl. G06Q 30/02; G06Q 20/34; G06Q 20/38; G06K 19/06; G06Q 20/14

(52) U.S. Cl. CPC G06Q 30/0233; G06K 19/06028; G06Q 20/14; G06Q 20/387; G06Q 20/342; G06Q 20/355

(57) ABSTRACT

A method of promoting a business of goods and services by a business entity is provided. The method involves sharing a proportion of the profit made by the business entity from a customer with the customer, wherein a proportion of the bill amount incurred by the customer is credited to an account/record associated with the customer and the customer could redeem a certain proportion of the accumulated balance in his/her record during their subsequent purchases. The shared profit could entice potential customers and bring back the old customers, without the need for the business entity to spend on advertisements, or providing discount coupons and vouchers.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates generally to a reward system, and more particularly, to sharing the business profit with the customers. The present invention also relates to a gift card, preferably a profit card that fascinates the new customers and brings back the old customers, through the advertising tactics.

### 2. Description of Related Art Including Information Disclosed Under 37 CFR 1.97 and 37 CFR 1.98.

Merchants have devised many methods and devices attempting to increase sales of the items or services they offer. For example, advertising, holding “sales” at discounted prices for at least some items, and providing discount coupons are some commonly used methods.

Merchants may use discount coupons in a variety of contexts. For example, discount coupons maybe printed along with an advertisement in a newspaper or magazine. Discount coupons may also be provided at a sales counter, handed out personally and available on the internet and via email.

“Gift certificates” have characteristics of discount coupons in that they are typically only valid for purchasing products or services from a particular merchant or group of merchants, and are provided having certain amount that is used like a currency to pay for goods or services.

“Gift cards” represent a recent improvement over gift certificates. “Gift cards” typically look like credit or debit cards and have either a coded number, bar code, computer-readable magnetic strip, or the like. This allows each gift card to act like a separate “account” with an initial value in currency, when activated.

Gift cards are typically given a certain denomination at the time of activation. That is, a user could use the gift card to purchase items at a store for a merchant accepting the gift card, and the amount of the purchase is deducted from the “account” associated with the card (the parameters of which are stored on a computer). Gift cards either may be purchased (for example, as a birthday gift) or may be given away for promotional purposes, in a similar manner to discount coupons. That is, a merchant may provide gift cards, in return for the consumer doing something desired by the merchant. For example, a merchant may provide a free gift card having a value of $10, $50, $100 or some other denomination, but that is valid only for certain time period, for example, before December 25th during the Christmas season. The hope for the merchant is that the person receiving the card will come into the store on that one day or during a certain time period to buy something that will give the merchant more overall profit than the cost of the gift card, even though that person was not planning on going into the store to buy anything at that location in the near future until the person received the gift card. By making the card valid on only for a certain time, it creates some “fear of loss” on the part of the person receiving the card, since the value of the card will be zero if not used during the dates of validation.

Restaurant gift cards are a popular way to give a gift for any occasion. In some cases, the gift-giver selects a particular restaurant, and a monetary value for the gift card, because the restaurant is a place the recipient cannot afford or would not normally frequent (e.g., due to the lavishness of the restaurant). This can place the recipient in an awkward situation as he or she tries to balance taking advantage of the gift, yet not spending too much over the stored value of the card (since he or she will have to personally pay the difference). Even for patrons who can comfortably afford to pay the difference between a gift card and the meal, the gift card represents an “incomplete gift” when the recipient has to contribute personal funds.

The problem with using gift cards for promotional purposes is that consumers are inundated with so many marketing messages, sales events, advertising and other promotional efforts by merchants that it is difficult for a particular merchant to hold the attention of a person in the target market long enough to deliver the promotional material.

A need exists for a new type of a card, which solves the above issues. The present invention fulfills those needs.

It is an aspect of the invention to overcome or alleviate a problem of the prior art. This permits the use of the present invention which enhance the prior art of the gift card system.

### BRIEF SUMMARY OF THE INVENTION

In view of the foregoing, one aspect of the various disclosed embodiments in the present invention is to provide a new method for promoting a business.

In another aspect, the present invention provides a gift card, preferably a profit share card.

Preferably, the method and system addresses, or at least ameliorate, one or more of the problems described above. To this end, the present invention, relates to the use of the gift cards, with some other unique aspects are disclosed.

Accordingly, it is a primary aspect of the present invention to provide a card, which shares the business profit with the customers.

It is an aspect of the present invention to bring such card in the market, which fascinates the new customers, and even bring the old customers back.

It is another aspect of the present invention to provide a card, specifically for restaurant business.

Additionally, the present invention provides a marketing tactic through advertising that would create a healthy loyal relationship between the owner and the customers.

It is yet another aspect of this invention to provide a card with a unique bar code at the back of the card for each customer.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

These together with other objects of the invention, along with the various features of novelty, which characterize the invention, are pointed out with particularity in the disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope.

The invention will be described and explained with additional specificity and detail through the use of the accompanying drawing in which:

FIG. 1 is a top view of the one exemplary embodiment of present which is a profit share card.

FIG. 2 is the back view of the profit share card illustrated in FIG. 1.

### DETAILED DESCRIPTION OF THE INVENTION

The various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Disclosed are systems, methods, and non-transitory computer-readable storage media for processing profit share gift cards. A first exemplary method embodiment includes receiving, from a giver, a profit share gift card, and an identification of a recipient or customer. The method embodiment further includes withdrawing the amount added in the customer's profit share card from a restaurant business account and identifying a recipient payment mode. Then the method includes applying the profit share gift card amount of money to a bill upon the recipient using the recipient payment mode to make the purchase.

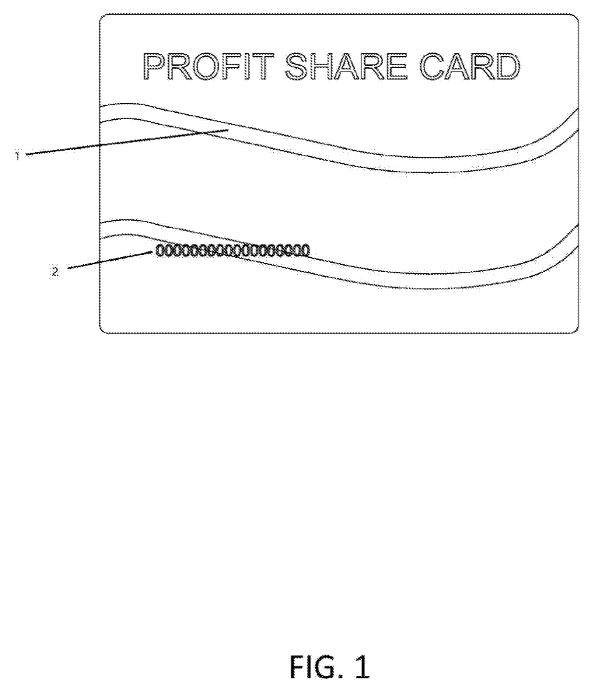

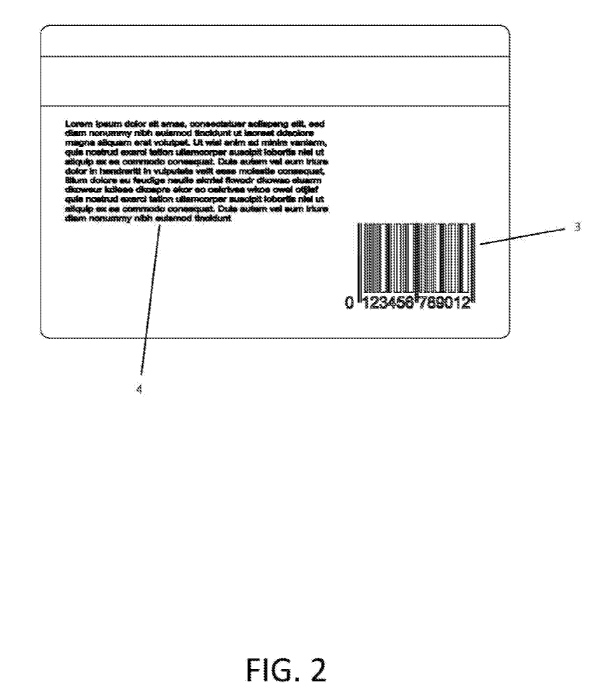

In one embodiment the present invention provides a method of promoting a business activity involving sale of goods and service and in particular a restaurant business. The businesses dealing in consumable goods and services could be particularly get benefitted from the present invention, as for an example, a business dealing in sale of groceries is frequently visited by the same customers, and similarly is the restaurant business. The current invention aims at retaining the old customers and enticing new customers, thus promoting the business. The present invention provides a gift card as shown in FIGS. 1 & 2 to a customer, the gift card illustrated in the figures is a thin rectangular piece of plastic having a front side illustrated in FIG. 1 and back side illustrated in FIG. 2. It is obvious however, that the card may be produced in any shape and size, such as round, square, rectangular with rounded edges etc. Moreover the card may have any color and indica, and preferably the appearance of the physical card may distinctly identify the card issuing business entity. It can be preferable embodiment, that a business entity get the card designed having unique appearance reflecting the branding of that business entity. Moreover, the business entity may provide physical cards of more than one appearance, and the different physical cards may have distinguished benefits. For example, the business entity may provide two cards of gold and silver color appearances wherein the gold card is provided to customers having monthly spending higher than a predetermined amount, while other customers can be provided with a silver card.

Turning to figures, the profit share card in accordance with the present invention is shown in schematic format to more clearly illustrate the components thereof The FIG. 1 depicts the front side of the gift card also referred here in as profit share card, which illustrates a two wave lines as a design 1, and a series of numerals 2 printed on the card. The FIG. 2 depicting the back image of the card shows a bar code 3 and general text information about the card 4.

The series of numerals 2 on the card is a unique identification code assigned to a customer by the business entity, for example the customers wishing to avail the profit share card may register themselves with the business entity and the business entity may issue a unique identification code to the registering customers, which may help to identify the customer without the need to find each time the name or other details provided at the time of registration. The unique identification code could be a series of numerals, or a combination of numerals and alphabets. The business entity may maintain a record or account of each registered user and associate the unique identity code to the respective record. The record and unique identification could be provided manually or automatically through a computing system, for example the business entity may maintain a written record of each registered customer. Alternatively, the computing system could be used to assign and maintain each record. For example, when a customer places a request to register for the profit share card, the software application provided in the computing system shows an option for registering new customers and selecting the option automatically assigns a unique identification number by the computing system based on the programmed instructions of generating the code. The codes could be generated randomly or in a series by the computing system. The computing system can also create an account or record and associate the record to the unique identification code. The user may manually enter the details like, name, address, phone no, e-mail id etc. into the record. The record contains other fields and could be similar to a bank relating financial records permitting recording the values credited, debited and the balance amount. Furthermore the records could have other fields like date and time at which a particular entry is made in the record. The records are saved in the memory of the computing device for example the records could be saved in the form of a database, such an example of electronic database include Microsoft access database.

The unique identification code is provided to a customer in the form of a physical card reflecting the branding of the business unit for example, the logo, trade name, contact information including phone number and address etc. The unique identification code could be printed as such, or provided in the form of a bar code printed on the card, or in magnetic form using a magnetic strip that could be attached to the physical card. Depending upon the type of form used in providing the unique identification code, suitable readers could also be provided, for example a bar code reader for the reading the bar codes imprinted in the card; a magnetic strip reader for reading magnetically stored unique identification code. Furthermore a user could also manually input the unique identification code into the computing system.

The current invention in one exemplary embodiment directs the business entity for sharing a predetermined share value with the customer, for example, the business entity may provide a certain percentage like 1%, 2% or 3% of the bill value to the customer. The predetermined share value could depend upon the profitability of the business and could be modified any time by the business entity without the discretion of the registered customers, for example during the month of march, the business entity may provide a discount of 3% of bill value as a predetermined share amount and may be providing a discount of 2% in April month. In a preferred embodiment, the present invention could provide a method of devising a suitable mathematical procedure for calculating the predetermined share value keeping in mind the different factors such as business profitability, investments, expenses etc. It is to be noted that the bill value could be the cost of the good or services which exclude the tax and service charges. The taxes could be levied on the amount having share value deducted, as the share amount is returned to the customer. In addition, it may be advantageous to exclude service charges from calculating the share value, for example the restaurants generally levy service charges apart from the cost of food. Alternatively, the business entity may also provide certain percent of share on the service charges. Furthermore, such mathematical procedure for calculating the predetermined share value shall also depend upon the marketing strategy or future business plans of the business entity.

The invention could be implemented in number of ways, such as the whole process of billing and discounting could be automated. As an example, the user may feed the list of goods or services availed by the customer into the computing system and the computing system may automatically calculate the total cost incurred by the customer, calculate the share value using the pre-programmed mathematical formula, deduce the calculated share value from the total cost to get the final cost, thereafter adding service charges if any and calculating the applicable taxes and adding the taxes to produces the bill amount that has to be paid by the customer. It may be preferable that the bill shows the calculated share value, for example as a discount and further a statement may be provided indicating that the shared amount is credited to the profit share card associated with the customer.

It is to be noted however that the computing system may perform only one or more steps of the billing process, for example the user manually feeds the share value into the computing system, whereby the computing system may credit the share value to the associated record.

In one embodiment, the registered customer avails the services or purchase goods from the business entity and shows his/her profit share card at the billing counter or to any a concerned person any time before the billing. The biller could then feed the purchased items or services into the computing system, which could then calculate the final bill value that has to be paid by the customer and credit the calculated share value to the record of the customer. In one embodiment, the method of present invention allows a customer to keep on accumulating the share values in their record/account, thus on every purchase their balance amount would increase. Furthermore, the customer could redeem the balance amount or a portion of their balance amount in there subsequent purchases, for example, the customer may redeem 25% of their balance amount during next purchase which gets deducted from the bill amount. It is to be noted that in case of bankruptcy of the business entity, all the balance amount associated with records and held by the business entity could be annulled by the business entity without any permission or notification to the customers. Moreover, in case the business entities may having more than one location of business, for example a chain of restaurants, a common database containing all the records could be shared by each part of the business entity, thus the customers could avail the benefits of the invention at any of the stores/restaurants of the business entity.

In accordance with the invention, the purpose of the profit share card is to share the profit of the business with the customer. The card is advantageous to the business owners also, as they need not to spend money for the gift coupons and vouchers to advertise and attract customers towards their business.

In another preferred embodiment, the profit share card may be a lifetime card that does not expire. The card may also not need any renewal policy.

The profit share card is an alternative form of communication to the customer, as it builds a strong loyal relationship between the business owner and the customers. The customer may be carrying the profit share card at all times, that being a constant reminder to the person about the restaurant business.

In yet another embodiment, the present invention discloses the profit share card which would be able to build funds. The customer when pays the amount, the amount of the percentages of the share the restaurant business offers to the customer varies. The amount could be any profit of the business.

In another embodiment, the profit share could be limited for each restaurant, say 1%, 2%, 3%, or so on. Unlike other businesses with other reward system, it offers the maximum benefit as: higher the share, higher the return.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

We claim:

1. A method of promoting a business of providing goods and services by a business entity comprising the steps of:
a. assigning a unique identification code by said business entity to a customer;
b. associating said unique identification code to a record and storing said record in a database;
c. providing a means to calculate a predetermined share value from a bill value incurred by said customer;
d. calculating said predetermined share value;
e. identifying said unique identification code assigned to said customer and crediting said calculated predetermined share value to said record associated with said unique identification code to give a balance amount; and
f. permitting said customer to redeem a proportion of said balance amount in a subsequent bill amount.

2. A method according to claim 1, wherein said unique identification code is provided in a form of a bar code, said bar code printed on a physical card.

3. The method of claim 2, wherein said method further comprises the step of providing a name and a contact information of said business entity printed on said physical card.

4. A method according to claim 1, wherein said unique identification code is provided in a form of a magnetic strip, said magnetic strip produced on a physical card.

5. An apparatus for promoting a business of providing goods and services by a business entity, said apparatus comprising:
a. a physical card comprising a unique identification code assigned to a customer; and
a name and a contact information of said business entity;
b. a computing system comprising a processor and a memory, said memory comprising a set of instruction which when executed by said processor performs one or more steps of:
i. assigning said unique identification code to said customer;
ii. associating said unique identification code to a record and storing said record in an electronic database;
iii. receiving a means to calculate a predetermined share valve from a bill value incurred by said customer;
iv. receiving said bill value and calculating said predetermined share valve;
v. crediting said calculated predetermined share valve to said record associated with said unique identification code providing a balance amount;
vi. permitting said customer to redeem a portion of said balance amount for a subsequent purchase.

6. The apparatus of claim 5, wherein said unique identification code is provided in a form of a bar code, said bar code printed on said physical card.

7. The apparatus of claim 6, wherein said apparatus further comprises a bar code reader.

8. The apparatus of claim 5, wherein said contact information include an address and a phone number.

9. The apparatus of claim 5, wherein said unique identification code is provided in a form of a magnetic strip, said magnetic strip produced on said physical card.

10. The apparatus of claim 6, wherein said apparatus further comprises a magnetic strip reader.
